(19) United States
(12) Patent Application Publication
(10) Pub. No.: US 2009/0132265 A1
(43) Pub. Date: May 21, 2009

(54) METHOD AND STRUCTURE FOR RAISING CHARITABLE FUNDS

(76) Inventor: David W. Chaveriat, Petoskey, MI (US)

Correspondence Address: JOHN K. MCCORMICK, 6781 GLACIER DRIVE, WEST BEND, WI, 53090, US

(21) Appl. No.: 11/942,261

(22) Filed: Nov. 19, 2007

(51) Int. Cl. G06Q 90/00

(52) U.S. Cl. 705/1

(57) ABSTRACT

A method and system for raising charitable donations in perpetuity, including the steps of: (a) having a digital memorial of an individual created and electronically stored, the memorial having a request for donations going to one or more charitable organizations; (b) having the television, radio, publication and web site rights to the memorial assigned over to an independent company; (c) presenting the memorial at the individual's funeral service and making the memorial available on the internet in perpetuity; (d) providing a plurality of means for people viewing the internet distributed memorial to make donations to said charitable organizations at any time; and (e) sublicensing the television, radio, publication and web site rights for further distribution to the public and using the sublicensing fees for additional charitable work.

### TECHNICAL FIELD

The present invention relates generally to the activity of raising charitable funds, and will specifically disclose a method and structure for raising charitable funds according to a deceased person's pre-determined wishes.

### BACKGROUND OF THE INVENTION

The rituals and ceremonies for commemorating the loss of a particular member of a community are as varied and diverse as the cultures and faiths of the people that commemorate a loss. Each community develops its own traditions and standards for the occasion. Such memorials typically have a viewing ceremony as well as an internment ceremony. These ceremonies are usually held within a couple of days or weeks after the individual has died and constitute a singular event, meaning that the services are a one time event for those present to pay their respects and to mourn the loss of a loved one.

Today, it is not uncommon at such commemorating events to have memorabilia of the individual's life presented or displayed in some manner such as poster boards, display tables, DVD's or video clips and the like. These memorabilia allow those present to view snapshots of the individual's life and significant moments. It is also common to have flowers, wreaths or cards with money donated by the attendees present at the funeral ceremony. In many cases, those who are unable to attend the ceremony send cards or flowers to the ceremony as well, although they are unable to view the memorabilia of the individual's life and significant moments.

Today, it is well known for the surviving family members or trustee of the estate of the deceased person to request that donations commemorating the deceased individual be given to one or more charities in lieu of flowers, wreaths or the like. Many times, the choice of the charity selected to receive the donations is based upon the survivors' beliefs in what the deceased person would have wanted for their memorial. In some instances, the deceased has provided directions prior to their death as to what charity they would like donations made to. Bereaved family members and friends may then place a donation in an envelope and drop it in a container at the ceremony site or they may contact the designated charity and arrange for a payment to the charity on behalf of the deceased individuals name.

While this method does raise some funds for various charities, the amount of charitable funds raised is generally limited due to the inaccessibility of the death notice and the wishes of the deceased to the public in general. Moreover, as the memorial for the deceased ends and a short time passes, the public and the attendees tend to quickly forget the charitable donation desires of the deceased and thus the charitable donations received as a result of the deceased wishes tend to be a one time event, similar to the funeral ceremonies, rather than a means to provide charitable funds over time.

Thus, it would therefore be desirable to provide a system and method that preserves an individual's memorial, and charitable donation request, in perpetuity. This would allow others, such as those unable to attend the ceremonies, grandchildren or great-grandchildren not yet born when the deceased passed away, and any others, to view the memorial of the departed, and if so inclined, make a donation to the requested charity at a point in time distant from the deceased individual's funeral ceremony thereby creating a means for raising charitable funds in perpetuity.

### SUMMARY OF THE INVENTION

Provided herewith is a system and structure for raising charitable funds through the request of a deceased individual. In its preferred embodiment, while alive, an individual donates a small sum of money to a charity of their choosing. The charity then contracts and pays, from the charitable donation, a professional licensed video production company who interviews the individual and creates a digitally captured memorial of the individual's life, thoughts, events and other particulars of importance to the individual.

Included in the digital memorial is a memorial request specifically asking for any donations to go to the charity of the individual's choice on their demise. The licensed video producer pays a small licensing fee to an independent company. The digitally captured video then becomes the property of the charitable organization that paid the video production company for the video memorial. The charitable organization then presents the video memorial back to the deceased's family or community at the time of the individual's death for presentation at the funeral services as a memorial and as a means to raise charitable funds.

In an alternative embodiment, the individual contracts and pays the licensed video producer directly for the creation of the video memorial. The video then becomes the property of the individual and/or their heirs and assigns. The heirs or assigns then present the video memorial at the individual's funeral to commemorate the individual and as a way to raise charitable funds for the individual's elected charity.

The video producer may provide a copy of the video memorial to the charity, to the individual and/or their trustee as well as providing a digital copy of the memorial to the independent company. The independent company contracts with another company, preferably a non-profit entity, to host the video memorial on a secure server. The licensing fees are used to pay the web hosting company for their services. The individual, designated charity and the video producer assign all of the television, radio, publication and web rights to the independent company. When the individual passes away, the digital memorial is played at their funeral service as well as being made available to the public through the world-wide web in perpetuity.

Anyone unable to attend the funeral services may view the memorial at their convenience through the web hosted service. Anyone viewing the web hosted memorial may choose to make a donation to the deceased individual's elected charity by either mailing a check to the charity, linking to the charity's website directly or by paying the independent company on-line. Any funds collected on-line by the independent company are the then aggregated and forwarded on to the charity.

Given that the video memorial is being hosted in perpetuity on the world-wide web, anyone, at any future date and time, may view the video memorial and, if they choose, make a donation to the elected charity. Thus, instead of a one time opportunity for making a donation to a charity based upon a deceased persons request at a funeral service, what is created is a method and structure for providing the opportunity for charitable donations long into the future. For example, a great-grandchild who was not yet alive when the deceased passed away would be able to view the video memorial in the future to understand and get to know their ancestor better. At that time, they could choose to make a donation as the deceased individual had requested.

In addition, if the deceased individual is a publicly well recognized person, such as a religious leader, a past president or other famous person, on their demise, there may be the opportunity to license the video memorial to television stations, radio stations, publications or the like for transmission to the public in general. This would provide the independent company with licensing fees which would then be redirected towards other charitable activities.

In other alternative embodiments, the actual funeral service could be digitally recorded and included with the video memorial on the world-wide web hosting site for future reference and viewing. Other advantages, modifications and alterations would be obvious to those skilled in the art and are therefore meant to be incorporated as part of this disclosure.

### BRIEF DESCRIPTION OF THE DRAWINGS

Other advantages, characteristics and particulars of the invention will become apparent to those skilled in the art from the explanatory description which follows taken in conjunction with the appended drawings, given merely by way of illustration and in which:

FIG. 1 is a schematic view of the two phases of the present invention,

FIG. 2 is a detailed schematic of the preferred embodiments of Phase I of the present invention,

FIG. 3 is a detailed schematic of an alternative embodiment of Phase I, and

FIG. 4 is a detailed schematic of Phase II of the present invention.

### DETAILED DESCRIPTION OF THE PREFERRED EMBODIMENTS

To facilitate the description of the invention, it is worthwhile to define some terminology solely for this purpose. This terminology is somewhat arbitrary and should not be construed as limiting the generality of the invention. For the purpose of this description:

1. Video memorial is meant to include the use of the current state of digitally recording pictorials and sound as well as including any and all future improvements and enhancements to the capturing and storage of pictorial and sound information;

2. World-wide web is meant to include the technology, equipment and systems, presently or in the future, used to facilitate communication through what is now know as the internet or world wide web (www).

Reference will now be made in detail to the description of the invention as illustrated in the drawings. Although the invention is described in connection with the drawings, there is no intent to limit the invention to the embodiment or embodiments disclosed therein. On the contrary, the intent is to include all alternatives, modifications, and equivalents included within the scope and spirit of the invention as defined by the appended claims.

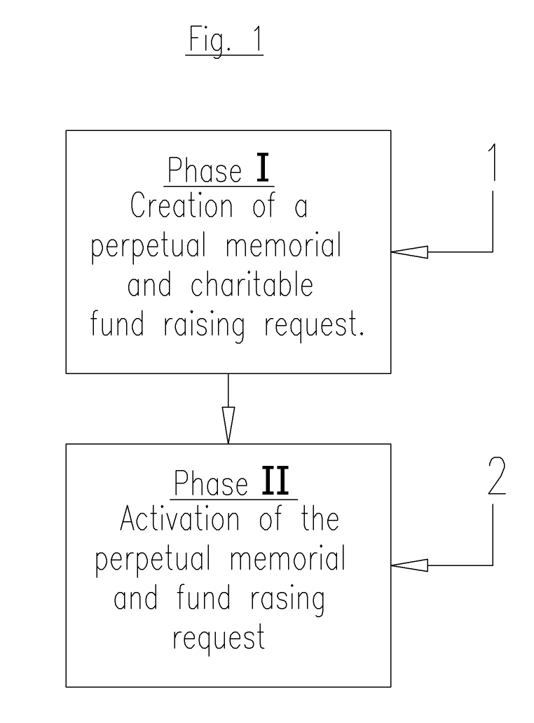

FIG. 1 is a schematic diagram of the two main phases of the perpetual memorial and charitable fund raising request. Generally, Phase I 1 provides the structure and means for the creation of the perpetual memorial and charitable fund raising request while an individual or entity is alive. Phase II 2 constitutes the activation of the perpetual memorial, with the charitable donation request, once the individual or entity passes away, thereby triggering the flow of donations to the designated charitable organization(s).

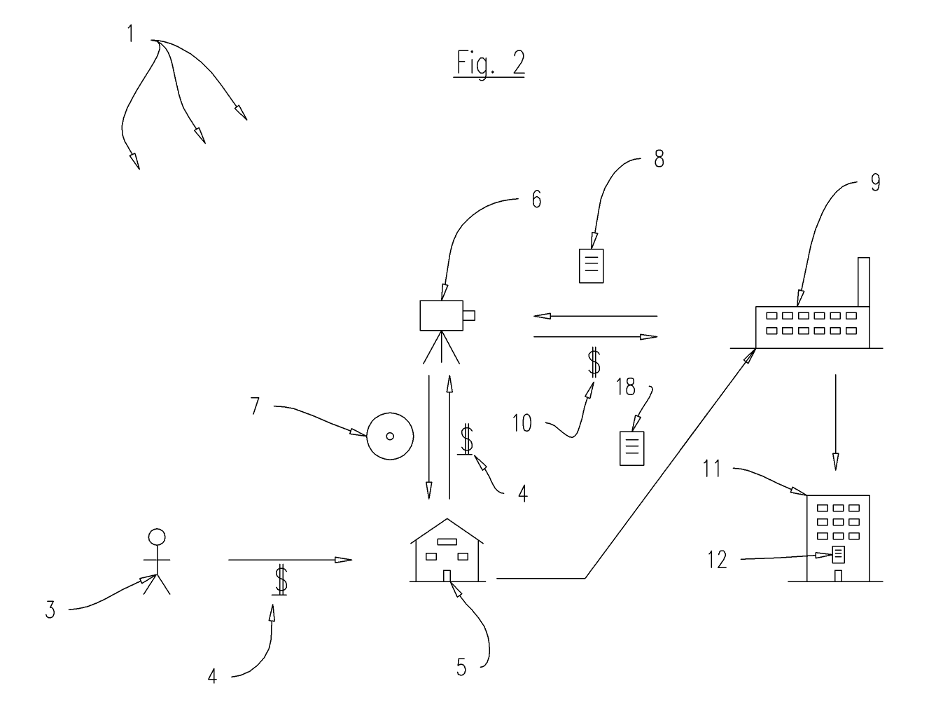

FIG. 2 is a schematic diagram of the preferred embodiments of the details of Phase I 1 of the present invention. In its preferred embodiment, an individual or entity 3 donates a small sum of money 4 or other valuable item to a charity 5. The charity 5 uses at least a portion of the donated money 4 to pay a licensed professional video producer 6 to make a digital memorial video 7 of the individual's 3 life story for publication and distribution on and after the individual's 3 death. A portion of the individual's 3 video memorial 7 contains the individual's 3 request for charitable donations to be made to a specified charity(s) 5. The charity then owns the rights to the digital video memorial 7.

The video producer 6 is an independent contractor working under a license 8 from an independent company 9. In return for the license 8, the video producer 6 pays a small licensing fee 10 to the independent company 9 as well as assigning, per the licensing agreement 8, any television, radio, printed publication and website rights to the video 7 over to the independent company 9. The charitable organization 5 also assigns 18 any television, radio, printed publications and website rights to the memorial video 7 over to the independent company 9.

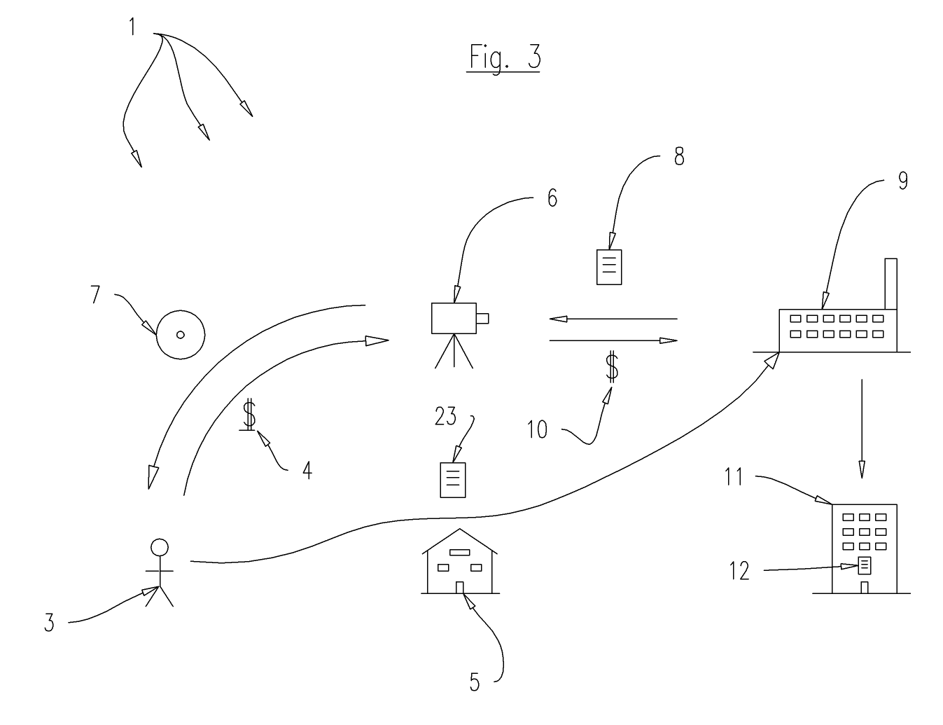

In an alternative embodiment of Phase I, as depicted in FIG. 3, the individual 3 contracts and pays 4 the licensed professional video producer 6 directly for the digital video memorial 7. The individual 3 then owns the rights to the digital memorial video 7 and assigns 23 any television, radio, printed publication and website rights over to the independent company 9.

After creating the video memorial 7, the video producer 6 provides a digital copy of the video memorial 7 to the elected charity 5 and/or to the individual 3 and/or their representative and/or to the independent company 9 for use in the event of the individual's 3 death. In the alternative, the digital memorial video 7 could be stored on a secure server 12 for access in the event of the individual's 3 death.

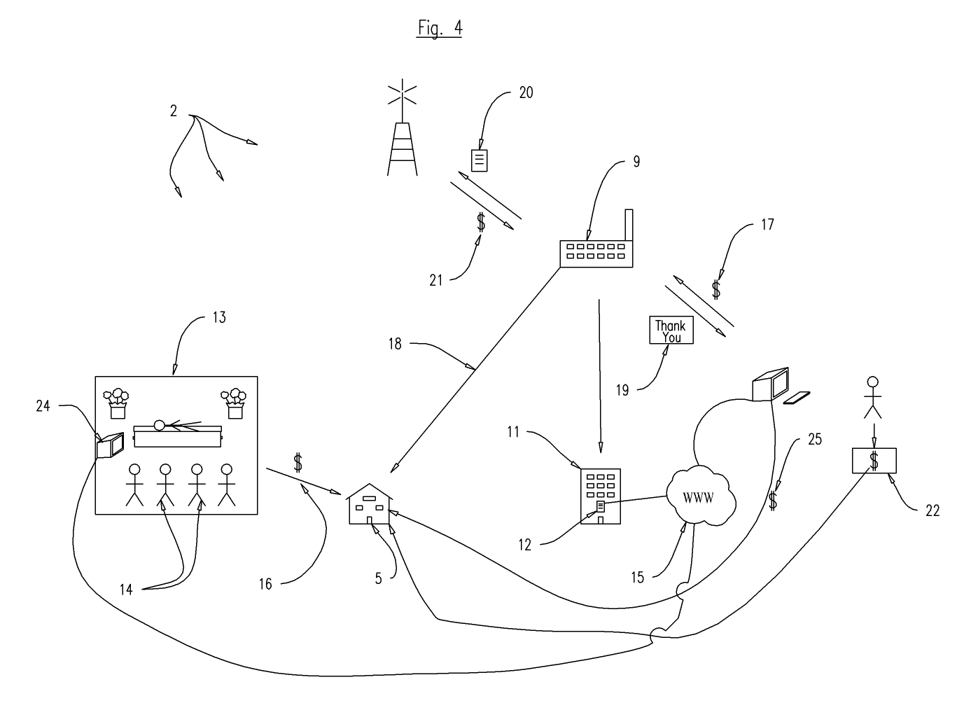

The independent company 9 then pays a second company 11, preferably a web hosting non-profit organization, to host the individual's 3 memorial video 7 on an internet server 12 with access to the world-wide web 15 shown in FIG. 4. However, the video memorial 7 located on the server 12 is not accessible by any of the public until the individual 3 has died.

In Phase II 2 as depicted in FIG. 4, once the individual 3 has departed this existence, the executor of the person's estate or family members then arrange for the funeral services 13 according to their specific customs and desires or the prior made directions of the deceased individual 3. In addition to those individuals and entities notified of the funeral services 13, the independent company 9 is also notified of the date and timing for the funeral services 13. The independent company 9 then notifies the web hosting company 11 of the details for the funeral services 13.

At the designated time and place for the funeral services 13, the memorial video 7 is presented to the attending mourners 14 either through streaming the video memorial 7 located on the remote server 12 to a display medium 24 or by playing a DVD or other electronic storage media containing the memorial video 7 located at the site of the funeral service 13. Simultaneously, the web hosting company 11 makes the video memorial 7 available on the world-wide web 15 for anyone who is interested in viewing the memorial video 7.

For those individuals 14 who attend the funeral service 13 and see the video memorial 7 or those who visit the web site to view the video memorial 7, there will be presented in the video memorial 7 a place wherein the deceased individual 3 will make a request that any donations 16, 17, 22 and 25 go to the charity 5 that the deceased individual 3 has selected.

In the case of the general public 27, those individuals 26 viewing the web hosted video memorial 7 will have the options of linking directly to the designated charities website to make a direct donation 25, make an on-line donation 17 by credit or debit card through the independent company 9 or, if the individual 26 desires, the mailing address of the charity will be provided for those who wish to make a donation 22 by check. For those individuals 26 making an on-line donation 17, the donated funds 17 will be collected and forwarded 18 onto the selected charity 5. A thank you card and/or tax donation acknowledgement 19 can be automatically generated as well and sent to the person 26 or entity making the on-line donation 17.

Unlike typical donations generated for a charity at a funeral service as a one time event, the web-hosted video memorial 7 can last in perpetuity on the world-wide web 15. Therefore, anyone 26 who chooses to visit the web-hosted video memorial 7, such as the general public 27 or descendants of the individual 3, or those too young to know or remember the individual 3, can go to the web-hosted video site and view the video memorial 7 in its entirety. Then, having viewed the memorial 7, if they so choose, they can make a donation 17, 22 and 25 to the charity 5 identified in the memorial video 7. Therefore, the deceased individual's 3 elected charity 5 has the potential for receiving donations 17, 22 and 25 long after the individual 3 has departed this earth and long after the funeral services 13 have been concluded.

In another alternative embodiment to the invention, the actual funeral services 13 could be digitally captured as the funeral services 13 took place. The digitally captured funeral services 13 could then be added to the web-hosted video memorial 7 such that any future viewers could watch the funeral services 13 as well as the video memorial 7 and the request for donations 17, 22 and 25.

In the case of most individuals 3, it is doubtful that the rights to television, radio, publications and or web-based presentations of the video memorial 7 would ever account for much. However, if the individual 3 was a person of well known notoriety, such as a past president, a religious leader, an actor or actress or the like, then the rights to the distribution or publication of that individual's 3 video memorial 7 may provide a further source of revenue, both currently and in the future. The rights to the video memorial 7 could be sub-licensed 20 to those desiring distribution or publication rights. Any funds 21 generated by these sub-licensing agreements 20 would then go to the independent company 9 which would then use these funds for additional charitable work.

In a further alternative embodiment, the charity 5 could be the independent company 9. In an additional alternative embodiment, the charity 5 could be the web-hosting company 11 as well.

I claim:

1. A method for raising charitable funds in perpetuity, comprising the steps of:
having a producer produce a digital memorial of a person, said producer having a license with an independent company to make said memorial, said digital memorial including a request by said person that any donations be given to one or more charitable organizations of said person's choice and giving said digital video to said person, said charitable organizations and said independent company, said independent company storing said digital memorial on a server connected to the internet;
said person said charity and said producer signing over all television, radio, publication and internet rights to said video to said independent company; and
when said person dies, at the date and time of said person's funeral, making available said memorial with said charitable organizations donation request to attending mourners and making said memorial with said donation request on said server available to the public in perpetuity through the world wide web, said memorial on said server having means for allowing memorial viewers to donate to said charitable organizations.

2. The method of claim 1, wherein said person, while alive, donates money to one or more charitable organizations and said charitable organizations pay said video producer to produce said digital memorial.

3. The method of claim 1, wherein said person pays said producer directly to have said digital memorial made.

4. The method of claim 1, wherein said means for said viewers to donate to said charitable organizations includes;
an internet link to said charitable organizations' website through said server;
the address of said charitable organizations for mailing donations in; and
a means for said independent company to accept credit card and debit card payments, said credit card and debit card payments being accumulated and transferred to said charitable organizations.

5. The method of claim 1, wherein said funeral services are digitally captured and made available on the world wide web through said server along with said digital memorial.

6. The method of claim 1, wherein said independent company sublicenses any of said rights to said television, radio, publication and internet rights to a second independent company for distribution and receives royalties back from said second company, said royalties being used to further support charitable organizations.

7. The method of claim 1, wherein said server is located at a non-profit organization.

8. The method of claim 4, wherein said donations made by said credit and debit cards to said independent company are tracked and a receipt and thank you card sent back to said viewers who donated.

9. A system for raising charitable funds, comprising:
a digitally captured memorial of an individual, said memorial including a request by said individual that any donations be given to one or more charitable organizations of said individual's choice;
assigning all of the television, radio, publication and web-site rights to said memorial to an independent company, said independent company storing said memorial on a server connected to the internet;
presenting said memorial to attendees at said individual's funeral services;
making said individual's memorial, and request for said donations, available for viewing by the general public on said internet in perpetuity;
providing a means for said attendees and said public to make donations to said charitable organizations.

10. The system of claim 9, wherein said individual, while alive, donates money to one or more charitable organizations and said charitable organizations pay said video producer to produce said digital memorial.

11. The system of claim 9, wherein said individual pays said producer directly to have said digital memorial made.

12. The system of claim 9, wherein said means for said attendees and said public to donate to said charitable organizations includes;
an internet link to said charitable organizations' website through said server;
the address of said charitable organizations for mailing donations in; and
a means for said independent company to accept credit card and debit card payments, said credit card and debit card payments being accumulated and transferred to said charitable organizations.

13. The system of claim 9, wherein said funeral services are digitally captured and made available on the world wide web through said server along with said digital memorial.

14. The system of claim 9, wherein said independent company sublicenses any of said rights to said television, radio, publication and internet rights to a second independent company for distribution and receives royalties back from said second company, said royalties being used to further support charitable organizations.

15. The system of claim 9, wherein said server is located at a non-profit organization.

16. The system of claim 12, wherein said donations made by said credit and debit cards to said independent company are tracked and a receipt and thank you card sent back to said viewers who donated.
